(19) United States
(12) Patent Application Publication
(10) Pub. No.: US 2026/0057208 A1
(43) Pub. Date: Feb. 26, 2026

(54) Dual Quantum Recurrent Neural Network with Attention for Time Series Prediction

(71) Applicant: International Business Machines Corporation, Armonk, NY (US)

(72) Inventors: Mansura HABIBA, Jhonstown (IE); Daniel Joseph FRY, Bucuresti (RO); Kavitha Hassan YOGARA, Bangalore (IN)

(21) Appl. No.: 18/814,773

(22) Filed: Aug. 26, 2024

(51) Int. Cl. G06N 3/044; G06N 10/40; G06N 10/60

(52) U.S. Cl. CPC G06N 3/044; G06N 10/40; G06N 10/60

(57) ABSTRACT

Systems or techniques that facilitate a dual quantum recurrent neural network with an attention mechanism for time series prediction are provided. In various embodiments, a system can receive a time series. In various cases, the system can further generate a prediction of the time series via a dual quantum recurrent neural network (QRNN), the dual QRNN comprising: a primary QRNN; and a controller QRNN that determines, via an attention mechanism, relevant past cell states of the primary QRNN, and wherein the primary QRNN generates the prediction of the time series based on the relevant past cell states.

### BACKGROUND

The subject disclosure relates generally to time series prediction, and more specifically to a dual quantum recurrent neural network with an attention mechanism for time series prediction.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate a dual quantum recurrent neural network with an attention mechanism for time series prediction are described.

According to one or more embodiments, a system is provided. The system can comprise a non-transitory computer-readable memory that can store computer-executable components. The system can further comprise a processor that can be operably coupled to the non-transitory computer-readable memory and that can execute at least one of the computer executable components that can receive a time series. In various aspects, the at least one of the computer executable components can further generate a prediction of the time series via a dual quantum recurrent neural network (QRNN), the dual QRNN comprising: a primary QRNN; and a controller QRNN that determines, via an attention mechanism, relevant past cell states of the primary QRNN, and wherein the primary QRNN generates the prediction of the time series based on the relevant past cell states.

According to one or more embodiments, a computer-implemented method is provided. In various embodiments, the computer-implemented method can comprise receiving, by a system operatively coupled to a processor, a time series. In various aspects, the computer-implemented method can comprise generating, by the system, a prediction of the time series via a dual quantum recurrent neural network (QRNN), the dual QRNN comprising: a primary QRNN; and a controller QRNN that determines, via an attention mechanism, relevant past cell states of the primary QRNN, and wherein the primary QRNN generates the prediction of the time series based on the relevant past cell states.

According to one or more embodiments, a computer program product for facilitating time series prediction is provided. In various embodiments, the computer program product can comprise a non-transitory computer-readable memory having program instructions embodied therewith. In various aspects, the program instructions can be executable by a processor to cause the processor to receive a time series. In various aspects, the program instructions can be further executable by the processor to cause the processor to generate a prediction of the time series via a dual quantum recurrent neural network (QRNN), the dual QRNN comprising: a primary QRNN; and a controller QRNN that determines, via an attention mechanism, relevant past cell states of the primary QRNN, and wherein the primary QRNN generates the prediction of the time series based on the relevant past cell states.

### DESCRIPTION OF THE DRAWINGS

One or more embodiments are described below in the Detailed Description section with reference to the following drawings:

FIG. 1 illustrates a block diagram of an example, non-limiting system that facilitates a dual quantum recurrent neural network (QRNN) with an attention mechanism for time series prediction in accordance with one or more embodiments described herein.

FIG. 2 illustrates an example, non-limiting block diagram of a dual QRNN in accordance with one or more embodiments described herein.

FIG. 3 illustrates an example, non-limiting block diagram of a dual QRNN in accordance with one or more embodiments described herein.

FIG. 4 illustrates an example, non-limiting block diagram of a dual QRNN in accordance with one or more embodiments described herein.

FIG. 5 illustrates an example, non-limiting block diagram of a dual QRNN in accordance with one or more embodiments described herein.

FIG. 6 illustrates a block diagram of an example, non-limiting system including a training component and a training dataset that facilitates a dual QRNN with an attention mechanism for time series prediction in accordance with one or more embodiments described herein.

FIG. 7 illustrates an example, non-limiting block diagram of a training dataset for training a dual QRNN with an attention mechanism for time series prediction in accordance with one or more embodiments described herein.

FIG. 8 illustrates an example, non-limiting block diagram showing how a dual QRNN with an attention mechanism for time series prediction can be trained in accordance with one or more embodiments described herein.

FIG. 9 illustrates a flow diagram of an example, non-limiting computer-implemented method that facilitates a dual QRNN with an attention mechanism for time series prediction in accordance with one or more embodiments described herein.

FIG. 10 illustrates a flow diagram of an example, non-limiting computer-implemented method that facilitates a dual QRNN with an attention mechanism for time series prediction in accordance with one or more embodiments described herein.

FIG. 11 illustrates a flow diagram of an example, non-limiting computer-implemented method that facilitates a dual QRNN with an attention mechanism for time series prediction in accordance with one or more embodiments described herein.

FIG. 12 illustrates a block diagram of an example, non-limiting operating environment in which one or more embodiments described herein can be facilitated.

### DETAILED DESCRIPTION

According to one or more embodiments, a system is provided. The system can comprise a non-transitory computer-readable memory that can store computer-executable components. The system can further comprise a processor that can be operably coupled to the non-transitory computer-readable memory and that can execute at least one of the computer executable components that can receive a time series. In various aspects, the at least one of the computer executable components can further generate a prediction of the time series via a dual quantum recurrent neural network (QRNN), the dual QRNN comprising: a primary QRNN; and a controller QRNN that determines, via an attention mechanism, relevant past cell states of the primary QRNN, and wherein the primary QRNN generates the prediction of the time series based on the relevant past cell states. Such embodiments can provide the advantage of increasing efficiency and accuracy of time series prediction, improving prediction of continuous multi-variate time series, and reduced quantum noise for time series prediction with quantum computing.

In one or more embodiments of the aforementioned system, the primary QRNN can comprise hidden states, wherein the primary QRNN generates the prediction based on the hidden states. Such embodiments can provide the advantage of increasing efficiency and accuracy of time series prediction.

In one or more embodiments of the aforementioned system, the controller QRNN can comprise: memory states that are hidden states outputted by the primary QRNN, and wherein determining the relevant past cell states via the controller QRNN comprises generating, via the attention mechanism, context states that represent an underlying data structure of the time series based on the memory states. Such embodiments can provide the advantage of improving accuracy and efficiency of time series prediction, and mitigating the vanishing gradient problem.

In one or more embodiments of the aforementioned system, the dual QRNN can comprise an augmented memory storage that stores the memory states, wherein the memory states represent attention-infused quantum states of the primary QRNN over time. Such embodiments can provide the advantage of improving accuracy and efficiency of time series prediction.

In one or more embodiments of the aforementioned system, e primary QRNN and the controller QRNN can comprise a variational quantum circuit (VQC). Such embodiments can provide the advantage of improving accuracy and efficiency of time series prediction.

In one or more embodiments of the aforementioned system, the primary QRNN can use the context states as the hidden states to generate the prediction or another hidden state. Such embodiments can provide the advantage of improving accuracy and efficiency of time series prediction.

In one or more embodiments of the aforementioned system, generating the context states via the attention mechanism comprise weighting the memory states based on the time series and the hidden states by assigning relevancy scores to the memory states. Such embodiments can provide the advantage of mitigating the vanishing gradient problem and improving accuracy and efficiency of time series prediction.

In one or more embodiments of the aforementioned system, the at least one of the computer executable components can further train the dual QRNN, wherein training the dual QRNN comprises adjusting, based on a loss function, a set of parameters to minimize an error between the prediction and a corresponding ground-truth, wherein the set of parameters comprises parameters of the VQC of the primary QRNN, parameters of the VQC of the controller QRNN, and parameters of the attention mechanism. Such embodiments can provide the advantage of improving overall model performance for time series prediction.

In one or more embodiments of the aforementioned system, the time series can comprise continuous data, a sequential time series, or a time series dataset. Such embodiments can provide the advantage of mitigating the vanishing gradient problem.

In one or more embodiments of the aforementioned system, the controller QRNN can determine the relevant past cell states of the primary QRNN for each time step in the time series. Such embodiments can provide the advantage of improving accuracy and efficiency of time series prediction.

The aforementioned system can further be implemented as a computer-implemented method or a computer program product.

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Quantum computing is increasingly being leveraged to tackle complex problems, many of which involve time series data. This advancement in quantum computing necessitates robust models that can be deployed across various domains, effectively mining vast datasets and addressing diverse challenges. For example, time series data or intelligence is critical in advancing areas such as pharmaceutical development, air traffic control, or power transmission.

Various existing techniques for performing time series prediction with quantum computing simulate time series data as a set of discrete data points or states over time. Accordingly, such techniques use the discrete dataset to train a quantum recurrent neural network (QRNN). However, simulating time series data as a set of discrete data points can hinder the QRNN's efficiency in handling multi-variable time series data, thus limiting its application in large-scale multi-variable time series contexts. Continuous multi-variable time series data is crucial for advancing numerous fields, yet existing techniques lack the capability to train effectively on continuous multi-variable time series data and are limited in their deployment across different problem domains. For instance, various existing techniques that involve designing quantum circuit for continuous-variable systems face challenges due to a continuous nature of parameters and variables, requiring specialized quantum algorithms tailored to handle continuous data.

Furthermore, quantum circuits are susceptible to noise. Various existing techniques that employ QRNNs for time series prediction are prone to underfitting or overfitting due to such noise. Such existing techniques lack methods to encode the time series data for training such that it preserves relevant information while avoiding effects of noise and decoherence. Some existing techniques may use data processing to mitigate noise during training, however, this approach can be time-consuming, computationally expensive, and inefficient.

Various embodiments of the present disclosure can be implemented to produce a solution to these problems. Embodiments described herein include systems, computer-implemented methods, and computer program products that can enable a dual quantum recurrent neural network with an attention mechanism for time series prediction.

In various embodiments described herein, there can be a time series. In various aspects, the time series can be received as input. The time series can comprise continuous data or discrete data. Further, the time series can be a sequential time series or a time series dataset. In various embodiments, an access component can electronically access the time series. In various embodiments, a prediction component can generate a prediction of the time series via a dual QRNN. In various aspects, the dual QRNN can generate the prediction based on relevant past cell states determined by an attention mechanism. Specifically, the dual QRNN can comprise a primary QRNN and a controller QRNN, wherein the controller QRNN determines, via the attention mechanism, the relevant past cell states of the primary QRNN. Accordingly, the primary QRNN can generate the prediction based on the relevant past cell states. In various embodiments, the controller QRNN can determine the relevant past cell states via the attention mechanism by generating a set of context states that represent an underlying data structure of the time series based on a set of memory states. In various aspects, the primary QRNN can comprise hidden states, wherein the hidden states outputted by the primary QRNN can be stored as the memory states. The context states generated by the controller QRNN can be received by the primary QRNN and used as the hidden states. Therefore, the primary QRNN can generate the prediction based on the relevant past cell states by generating the prediction based on the hidden states that are determined from the context states.

In various embodiments, a training component can train the dual QRNN. The primary QRNN and the controller QRNN can comprise variational quantum circuits (VQCs). In various aspects, the training component can train the dual QRNN by adjusting a set of parameters of the VQC of the primary QRNN, of the VQC of the controller QRNN, and of the attention mechanism. Training the dual QRNN can further comprise adjusting the set of parameters based on a loss function to minimize an error between a prediction of a time series and a corresponding ground-truth.

Various embodiments described herein can be considered as being advantageous over existing techniques. Indeed, the dual QRNN can model and learn continuous multi-variate time series data efficiently. Moreover, dual QRNNs with an attention mechanism can enable deployment for time series prediction over various different problem domains by training on continuous multi-variate time series data. Further, the dual QRNN can exhibit higher accuracy in generating predictions of time series data via an attention mechanism. In other words, a dual QRNN can have a higher propensity for accurately or reliably predicting time series data by utilizing an attention mechanism to identify relevant states. Specifically, the attention mechanism can selectively attend to relevant measurement outcomes (e.g., quantum states) of a quantum circuit, improving performance of the dual QRNN. In some cases, the attention mechanism can also focus on relevant measurements that are less impacted by noise in the quantum circuit, thereby improving accuracy of the dual QRNN. Therefore, various embodiments described herein can be considered as a more accurate, reliable, and efficient way of predicting time series data, as compared to existing techniques.

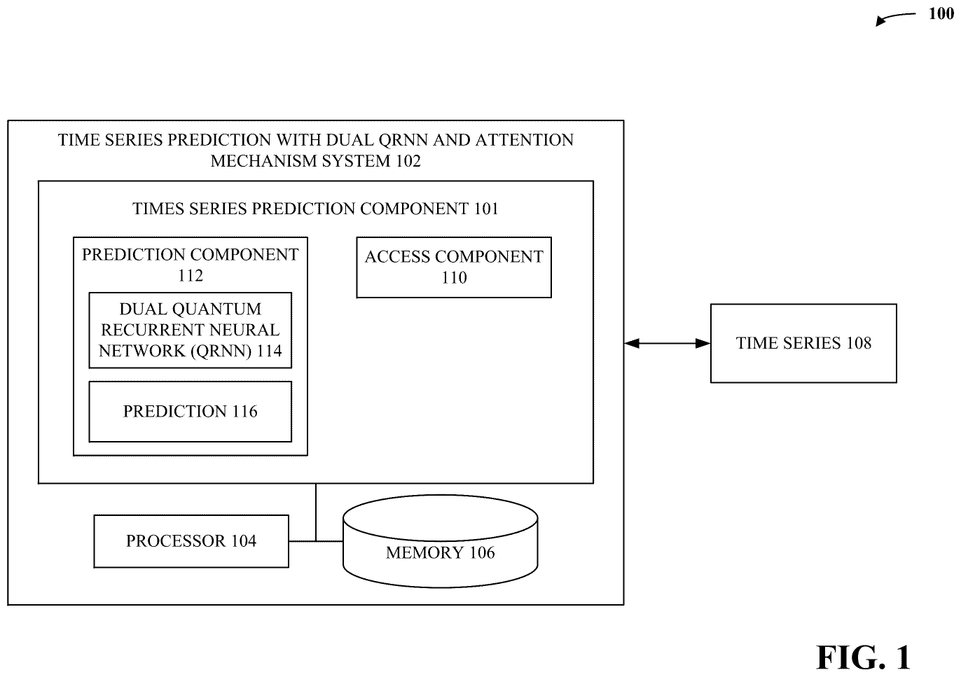

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1300 illustrated at FIG. 13. For example, non-limiting system 100 can be associated with, such as accessible via, a computing environment 1300 described below with reference to FIG. 13, such that aspects of processing can be distributed between non-limiting system 100 and the computing environment 1300. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that facilitates a dual QRNN with an attention mechanism for time series prediction in accordance with one or more embodiments described herein. Non-limiting system 100 can comprise processor 104, memory 106, time series prediction component 101, access component 110, prediction component 112, and/or dual QRNN 114.

Non-limiting system 100 and/or the components of non-limiting system 100 can be employed to use hardware and/or software to solve problems that are highly technical in nature (e.g., related to continuous time series prediction, quantum computing, QRNNs, etc.), that are not abstract and that cannot be performed as a set of mental acts by a human. Further, some of the processes performed may be performed by specialized computers for carrying out defined tasks related to time series prediction. Non-limiting system 100 and/or components of the system can be employed to solve new problems that arise through advancements in technologies mentioned above, computer architecture, and/or the like. Non-limiting system 100 can provide technical improvements to time series prediction by improving processing efficiency and accuracy for prediction of continuous multi-variate time series, improving performance of QRNN models for time series prediction, and/or improving interpretability of quantum models, etc.

Discussion turns briefly to processor 104 and memory 106 of non-limiting system 100. For example, in one or more embodiments, non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., time series prediction component 101, acc access component 110, prediction component 112, and/or dual QRNN 114) to perform one or more actions. In one or more embodiments, memory 106 can store computer-executable components (e.g., time series prediction component 101, access component 110, prediction component 112, and/or dual QRNN 114).

In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to processor 104 and/or memory 106 described above, non-limiting system 100 can comprise one or more computer and/or machine readable, writable and/or executable components and/or instructions that, when executed by processor 104, can enable performance of one or more operations defined by such component(s) and/or instruction(s).

In various embodiments, there can be a time series 108. In various cases, the time series 108 can comprise any suitable size (e.g., any suitable number of time series, time steps, data points, variables, etc.). In various aspects, the time series 108 can be any suitable electronic data (e.g., one or more scalars, one or more vectors, one or more matrices, one or more tensors, one or more character strings, or any suitable combination thereof). In some embodiments, the time series 108 can comprise continuous data (e.g., values defined at any time point within the time series 108) or discrete data (e.g., sequence of values at distinct, separate time intervals). Further, in various instances, the time series 108 can be a sequential time series or a time series dataset. A sequential time series can comprise a single series of data points in ordered time, where each data point is dependent on or related to previous data points (e.g., stock prices over time, temperature readings). A time series dataset can comprise collection of two or more time series, where the one or more time series can represent different variables or measurements in ordered time (e.g., multiple sensor readings over time, financial metrics across different companies).

As a non-limiting example, the time series 108 can be a series of continuous temperature and humidity readings taken every minute over a 24-hour period (or any subset of those readings). As another non-limiting example, the time series 108 can be daily stock prices recorded over a year (or any subset of those prices). As still another non-limiting example, the time series 108 can include hourly power consumption and temperature measurements from various sensors in a building over a month (or any subset of those readings). As even another non-limiting example, the time series 108 can consist of weekly sales figures for multiple products over a quarter (or any subset of those figures).

In any case, it can be desired to generate a prediction of the time series 108 such that the prediction is based only on relevant past cell states. As described herein, the time series prediction with dual QRNN and attention mechanism system 102 can facilitate or accomplish such objectives.

In various embodiments, the time series prediction with dual QRNN and attention mechanism system 102 can comprise time series prediction component 101. In various aspects, the time series prediction component 101 can comprise sub-components (e.g., access component 110, prediction component 112, dual QRNN 114).

In various embodiments, the time series prediction component 101 can comprise an access component 110. In various aspects, the access component 110 can electronically access the time series 108. As a non-limiting example, the access component 110 can electronically retrieve or otherwise electronically obtain the time series 108 from any suitable centralized or decentralized data structures (not shown) or from any suitable centralized or decentralized computing devices (not shown). In any case, the access component 110 can electronically access the time series 108, such that the access component 110 can serve as a conduit through which other components of the time series prediction with dual QRNN and attention mechanism system 102 can electronically interact with the time series 108.

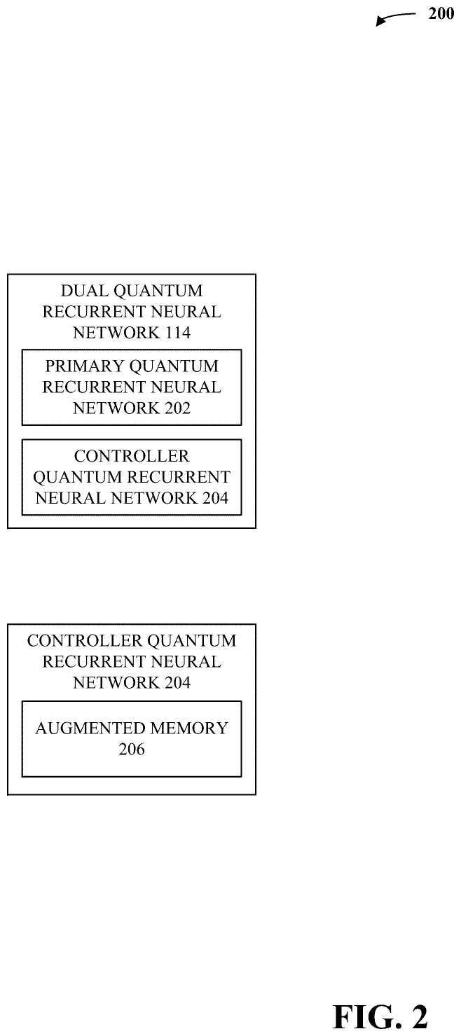

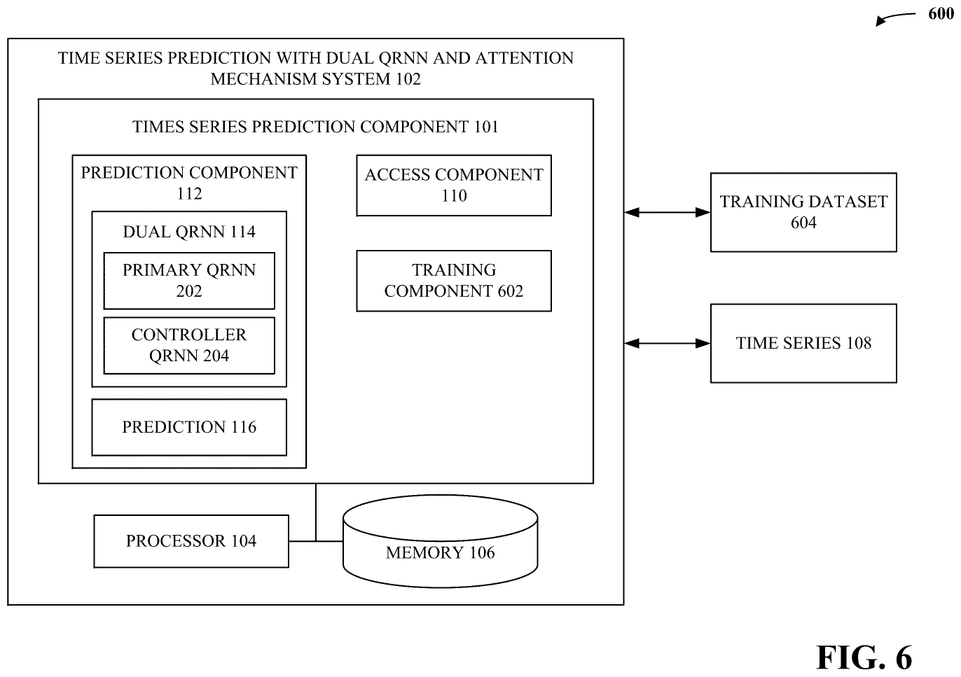

In various embodiments, the time series prediction component 101 can comprise a prediction component 112. In various aspects, as described herein, the prediction component 112 can generate a prediction 116 of the time series 108 via a dual QRNN 114. In various embodiments, the prediction component 112 can electronically store, electronically maintain, electronically control, or otherwise electronically access the dual QRNN 114. Various aspects of an internal architecture of the dual QRNN 114 are described with respect to FIGS. 2-5. In order for the time series prediction with dual QRNN and attention mechanism system 102 to function accurately, correctly, or reliably, the dual QRNN 114 can first undergo training, as described with respect to FIGS. 6-8.

The dual QRNN 114 can be configured with an attention mechanism for time series prediction. In other words, the dual QRNN 114 can be configured to receive time series 108 (which can be accompanied by any suitable numerical or graphical data) as input and to generate the prediction 116 of the time series 108, where prediction 116 is generated based on relevant past cell states. The dual QRNN 114 can enable more efficient prediction of time series than RNNs by combining convolutional and recurrent layers that are designed for handling sequential data while capturing long-term dependencies. Furthermore, the dual QRNN 114 can enable parallelization of computations, making it more efficient compared to fully sequential models. Thus, training and inference speed can also be increased. Moreover, the dual QRNN 114 can capture local and global context in sequential data, allowing for understanding of dependencies at different scales. Therefore, the dual QRNN 114 can be advantageous for tasks that involve short-range and long-range dependencies.

In various aspects, the prediction 116 can comprise any suitable size (e.g., any suitable number of time step predictions, data points, sequences, intervals, etc.). In various aspects, the prediction 116 can be any suitable electronic data (e.g., one or more scalars, one or more vectors, one or more matrices, one or more tensors, one or more character strings, or any suitable combination thereof). In any case, the prediction 116 can be any suitable data that is deemed (e.g., by the dual QRNN 114) as an accurate prediction of the time series 108.

FIG. 2 illustrates an example, non-limiting block diagram 200 of a dual QRNN in accordance with one or more embodiments described herein.

In various embodiments, the dual QRNN can comprise a primary QRNN 202. In various aspects, the dual QRNN can further comprise a controller QRNN 204. In various instances, the dual QRNN 114 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers (e.g., regression layers, classification layers), whose learnable or trainable parameters can be weight matrices or bias values. As even another example, any of such input layer, one or more hidden layers, or output layer can be batch normalization layers, whose learnable or trainable parameters can be shift factors or scale factors. As still another example, any of such input layer, one or more hidden layers, or output layer can be quasi-recurrent layers whose learnable or trainable parameters can be convolutional kernels or pooling operations. As even another example, any of such input layer, one or more hidden layers, or output layer can be recurrent layers, whose learnable or trainable parameters can be input weights, recurrent weights, and bias terms. As yet example, any of such input layer, one or more hidden layers, or output layer can be quantum layers, where the learnable or trainable parameters involve quantum gates, such as rotation angles or coupling coefficients, that control the manipulation of quantum states and their evolution over time. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

Regardless of the specific internal architecture (e.g., the specific number, types, or organization of layers) implemented within the dual QRNN 114, the dual QRNN 114 can be configured for time series prediction. In other words, the dual QRNN 114 can be configured to receive time series 108 (which can be accompanied by any suitable numerical or graphical data) as input and to generate prediction 116 of the time series 108. Specifically, the input layer can receive the time series 108 as input, and the output layer can generate the prediction 116, where prediction 116 represents future states or predictions of the time series 108.

In various embodiments, the dual QRNN 114 can comprise the primary QRNN 202 and the controller QRNN 204. That is, the dual QRNN 114 can have a primary QRNN layer and a controller QRNN layer.

In various aspects, the prediction component 112 can electronically execute the dual QRNN 114 on the time series 108. In various instances, such execution can cause the dual QRNN 114 to produce the prediction 116. More specifically, the prediction component 112 can feed or route the time series 108 to an input layer of the dual QRNN 114. In various aspects, the time series 108 can complete a forward pass through one or more hidden layers of the dual QRNN 114, the primary QRNN layer, and the controller QRNN layer. Such process can be performed iteratively, with each time step of the time series 108 being processed sequentially to update the current state of the dual QRNN 114. In various instances, an output layer of the dual QRNN 114 can calculate or compute the prediction 116, based on activation maps or feature maps generated by the one or more hidden layers.

In various aspects the primary QRNN 202 and the controller QRNN 204 can have any suitable hybrid quantum-classical neural network internal architecture. The QRNN of the primary QRNN 202 and the controller QRNN 204 belongs to a class of hybrid quantum-classical algorithms, including quantum long short-term memory (QLSTM), quantum gated recurrent unit (QGRU), bidirectional implementations, or quantum reservoir computing implementations. Hybrid quantum-classical algorithms combine quantum computing's capabilities, such as superposition and entanglement, with classical neural network structures to enhance the processing and prediction of sequential data. In various embodiments, the primary QRNN 202 and the controller QRNN 204 can comprise a variational quantum circuit (VQC). A VQC is a parameterized quantum circuit used as a quantum layer in the primary QRNN 202 and the controller QRNN 204. VQCs are tunable and can be optimized during training of the dual QRNN 114 to learn from the time series 108.

In some instances, the primary QRNN 202 can have one or more convolutional layers whose learnable or trainable parameters can be convolutional kernels. The one or more convolutional layers can enable local context extraction of the time series 108. In some cases, the primary QRNN 202 can have one or more recurrent layers whose learnable or trainable parameters can be input weights, recurrent weights, and bias terms. The one or more recurrent layers can enable sequential learning of the time series 108. In some cases, the primary QRNN 202 can have one or more quasi-recurrent layers whose learnable or trainable parameters can be convolutional kernels or pooling operations. The one or more quasi-recurrent layers can enable efficient learning of sequential dependencies of the time series 108. Furthermore, the primary QRNN 202 can employ various hyperparameters, such as kernel sizes, strides, or filters, to tailor the learning process of time series 108. In any case, the primary QRNN 202 can be configured to learn and predict the time series 108. The primary QRNN 202 can operate similarly to classical recurrent neural networks but can further integrate quantum computing advantages via the VQC, such as higher processing capabilities and improved handling of complex patterns that can be difficult for purely classical systems.

In various embodiments, the controller QRNN 204 can comprise an attention mechanism. In various aspects, the controller QRNN 204 can comprise an augmented memory 206. In various instances, the augmented memory 206 can comprise any suitable structure, such as a dynamic memory network. The augmented memory 206 can store past states or past outputs of the dual QRNN 114 (e.g., past outputs of the primary QRNN 202). Such embodiments can provide a number of advantages over RNNs or existing systems with attention mechanisms. Specifically, for example, RNNs typically use forget gates (e.g., a forget gate controls the retention or discarding of previous information by determining which parts of the past state should be kept or forgotten based on the current input). Other existing systems with attention mechanisms (e.g., Transformers), for example, use attention scores to determine which information is less relevant, however the less relevant information is effectively ignored or discarded during processing. Conversely, the augmented memory 206 can store past states or past outputs of the dual QRNN 114 and enable the controller QRNN 204 to identify and learn, via the attention mechanism, underlying relationships of the time series 108. In particular, the attention mechanism can dynamically assign weights that indicate relevance of the data to focus on specific data in the augmented memory 206 depending on the current state of the dual QRNN 114. Thus, the controller QRNN 204 can exhibit improved learning of temporal dependencies and data relationships.

In any case, the controller QRNN 204 can be configured to dynamically select the relevant past cell states from the augmented memory 206. The controller QRNN 204 can select the relevant past cell states by learning which states in the augmented memory 206 are most relevant at each time step. The controller QRNN 204 with the attention mechanism can mitigate vanishing gradients in QRNNs. Vanishing gradients occur when gradients become exceedingly small during backpropagation, hindering the learning process in deep neural networks. Vanishing gradients can affect a QRNN's ability to learn from long-term dependencies and propagate useful gradients through time. The controller QRNN 204 with the attention mechanism can mitigate vanishing gradients in QRNNs by enabling the primary QRNN 202 to focus on specific parts of an input sequence directly. This can reduce the dependency on long-term gradients flowing through multiple time steps, which can mitigate the vanishing gradient problem. Furthermore, the ability of the dual QRNN 114 to train or learn continuous time series data can mitigate the vanishing gradient problem. In particular, continuous data can allow the controller QRNN 204 to learn temporal dependencies more effectively as opposed to discrete data. Additionally, continuous data can enable the controller QRNN 204 to more accurately learn long-term dependencies, which can further mitigate the vanishing gradient problem.

In various aspects, the attention mechanism can facilitate quantum state influence of the dual QRNN 114. Although the primary QRNN 202 and the controller QRNN 204 manipulate quantum states via their respective VQCs, the attention mechanism can assign weights based on relevancy depending on a current input and past states of the dual QRNN 114. Therefore, the attention mechanism, while classically computed, can influence which quantum states of the dual QRNN 114 are considered more relevant. Accordingly, based on the weights assigned by the attention mechanism to determine the relevant past cell states, subsequent cycles of quantum computation can be influenced based on the weights, and thereby influence the evolution of the quantum states of the dual QRNN 114 over time. In some instances, the controller QRNN 204 with the attention mechanism can act as a dynamic filter for the primary QRNN 202 by selecting which states will influence a current computation. Such interaction between the primary QRNN 202 and the controller QRNN 204 allows the dual QRNN 114 to leverage both classical and quantum computational advantages, and thereby improve performance of the dual QRNN 202 for handling complex time series data more effectively.

In some cases, the attention mechanism can be an attention network (e.g., a type of neural network architecture that uses attention mechanisms to dynamically focus on specific parts of input data when making predictions). Attention networks can assign different weights to different parts of an input, allowing the controller QRNN 204 to prioritize the most relevant information in determining the relevant past cell states, enhancing the ability of the controller QRNN 204 to capture dependencies and context.

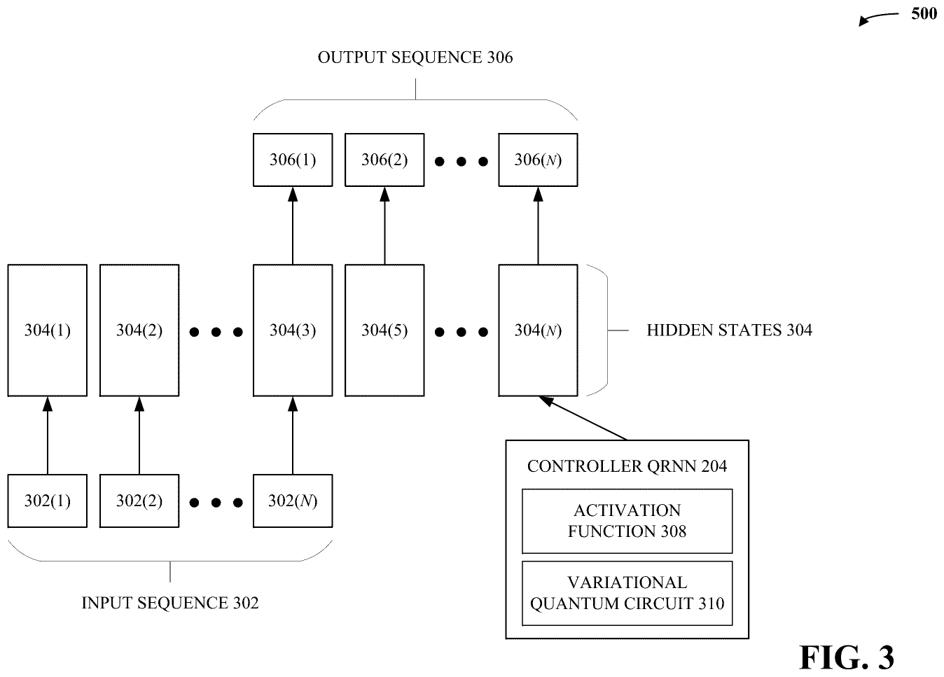

FIG. 3 illustrates an example, non-limiting block diagram 300 of a dual QRNN in accordance with one or more embodiments described herein.

In various aspects, the dual QRNN 114 can receive the time series 108 as an input sequence 302. For instance, in various embodiments, the input sequence 302 can comprise n tokens, for any suitable positive integer n>1: a token 304(1) to a token 304(n). In various aspects, the input sequence 302 can be any suitable electronic data (e.g., one or more scalars, one or more vectors, one or more matrices, one or more tensors, one or more character strings, or any suitable combination thereof).

In various embodiments, the dual QRNN 114 can initialize a set of hidden states 304 (e.g., initialized to zero, initialized to a predefined value). Specifically, the primary QRNN 202 can comprise the set of hidden states 304. For instance, in various embodiments, the set of hidden states 304 can comprise n hidden states: a hidden state 304(1) to a hidden state 304(n). Particularly, the primary QRNN 202 can receive a token 302(i) of the input sequence 302 for any integer 1≤i≤n. Accordingly, the primary QRNN 202 can compute and update a hidden state 304(i). As each token of the input sequence 302 is processed (e.g., token 302(i)), it is combined with the previous hidden state (e.g., hidden state 304(i−1)) using the weights of a VQC 310 and activation function 308 from the controller QRNN 204. The combination of the token 302(i) and the previous hidden state (e.g., hidden state 304(i−1)) is used to compute the new hidden state (e.g., hidden state 304(i)). This update reflects the current understanding of the dual QRNN 114 of the input sequence 302 based on the input received so far. The new hidden state is then used as the previous hidden state for the next token in the input sequence 302, continuing the process iteratively through the entire input sequence 302.

In various aspects, the set of hidden states 304 can be passed to the output layer of the dual QRNN 114. Accordingly, the output layer can generate an output sequence 306. For instance, in various embodiments, the output sequence 306 can comprise n tokens: a token 306(1) to a n 306(n). In particular, for each update hidden state, the updated hidden state (e.g., hidden state 304(i)) can be passed to the output layer of the dual QRNN 114, and the output layer can generate a token 306(i) the for the current time step. The token 306(i) can be used for immediate predictions or passed as part of the input to subsequent layers or time steps. In any case, the output sequence 306 can represent the prediction 116 of the time series 108.

In various embodiments, the set of hidden states 304 can be determined by the controller QRNN 204. More specifically, the VQC 310 of the controller QRNN 204 can leverage the attention mechanism of controller QRNN 204 to compute the set of hidden states 304, where quantum principles can influence the weights determined by the attention mechanism or the quantum computations.

In various aspects, the VQC 310 is a component of the controller QRNN 204 that performs quantum computations. The VQC 310 can processes quantum states using parameterized quantum gates, such as rotation and entangling gates. In various instances, the VQC can apply a series of quantum gates to input quantum states. Such input quantum states can be the set of hidden states 304 that are stored in the augmented memory 206 of the controller QRNN 204. The parameters of these gates (e.g., rotation angles) are learnable and can be optimized during training to improve performance of the controller QRNN 204. In various cases, the VQC 310 can generate an output that is a quantum state that encapsulates the learned features of the input data. In other words, the VQC 310 can generate states that represent an underlying data structure of the time series 108 based on the quantum states stored in the augmented memory 206. Accordingly, such states can be received and used by the primary QRNN 202 as the set of hidden states 304.

In various embodiments, before receiving the states to be used as the set of hidden states 304 by the primary QRNN 202, the states can be passed through the activation function 308. The activation function 308 can introduce non-linearity into the dual QRNN 114, allowing it to capture complex patterns and relationships within the time series 108. As non-limiting examples, the activation function 308 can include sigmoid, tanh, or Rectified Linear Unit (ReLU). The choice of activation function 308 can be selected based on types of data of the time series 108 or based on a desired task to be performed.

In any case, the controller QRNN 204 can learn, via the attention mechanism, relevant information from the set of hidden states 304 to determine subsequent hidden states.

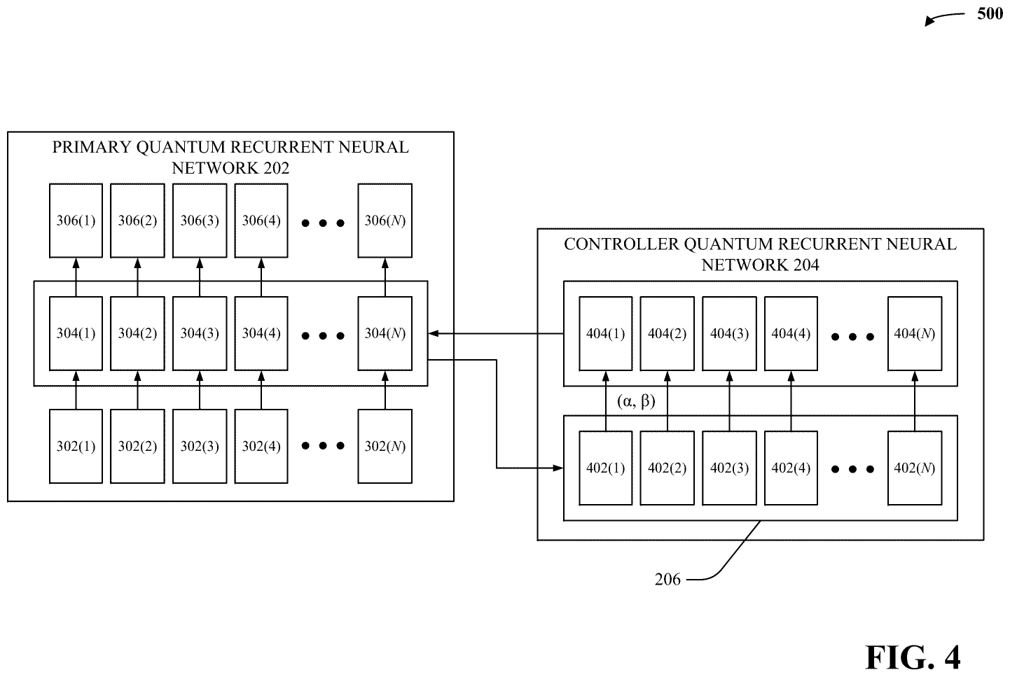

FIG. 4 illustrates an example, non-limiting block diagram 400 of a dual QRNN in accordance with one or more embodiments described herein.

In various embodiments, the primary QRNN 202 can sequentially receive the input sequence 302. For instance, the primary QRNN 202 can first receive the token 302(1). In response to receiving the token 302(1), the primary QRNN 202 can update the hidden state 304(1) based on the token 302(1). In various embodiments, the set of hidden states 304 can be stored in the augmented memory 206 as they are updated based on current input and past states of the dual QRRN 114. For example, the augmented memory 206 can store hidden state 304(1). Similarly, in response to receiving any token 302(i), the primary QRNN 202 can update the hidden state 304(i). Accordingly, the augmented memory 206 can store hidden state 304(i).

In various aspects, the hidden states that are stored in the augmented memory 206 are referred to herein as memory states 402. In various embodiments, the controller QRNN 204 can access the augmented memory 206 and thus the memory states 402. The memory states 402 can be used as input to generate, via the attention mechanism, context states 404. In various instances, the context states 404 can be any suitable electronic data (e.g., one or more scalars, one or more vectors, one or more matrices, one or more tensors, one or more character strings, or any suitable combination thereof). In various aspects, the context states 404 represent the underlying data structure of the time series 108 (e.g., the input sequence 302) based on the memory states 402. In various embodiments, the memory states 402 can represent attention-infused quantum states of the primary QRNN 202. That is, the context states 404 generated via the attention mechanism can be used by the primary QRNN 202 in the set of hidden states 304. Accordingly, the set of hidden states 304 can be stored as the memory states 402 to represent attention-infused quantum states of the primary QRNN 202 in the augmented memory 206.

The context states 404 can be considered as acting as a controller of the primary QRNN 202 by determining which hidden states from the memory states 402 are relevant to the current quantum state of the primary QRNN 202. Particularly, the context states 404 can control the primary QRNN 202 by using the context states 402 as the subsequent hidden states in the set of hidden states 302. For instance, for a time t, the controller QRNN 204 can leverage the memory states 402 to generate context state 404(1). Thus, context state 404(1) can be used as hidden state 304(t+1). In some cases, the controller QRNN 204 can leverage the previous memory states (e.g., memory state 402(t−k)) or future memory states (e.g., memory state 402(t+k)) to determine context state 404(1), and therefore hidden state 304(t+1), enabling the dual QRNN 114 to capture long-term dependencies or disregard irrelevant past data more effectively.

In various embodiments, the controller QRRN 204 can generate the context states via the attention mechanism. More specifically, the attention mechanism can assign relevancy scores (e.g., denoted by a) to the memory states 402 that are based on the input sequence 302 and the set of hidden states 304. Based on the relevancy scores, and any other suitable parameters or weights (e.g., denoted by β), the controller QRNN 204 can generate the context states 404. Therefore, the context states 404 can be used as the set of hidden states 302 for subsequent time steps. Accordingly, the primary QRNN 202 can generate prediction 116 based on the context states 404 through the set of hidden states 304.

In any instance, the controller QRNN 204 can determine which past states are relevant to prediction at each time step. Such embodiments can increase efficiency of generating output sequence 306 (e.g., prediction 116) by reducing an amount of data that is used to learn the input sequence 302 (e.g., time series 108) and focusing resources of the dual QRNN 114 on only the relevant past states. For example, this can increase the efficiency in predicting multi-variate time series, as multi-variate time series comprise large amounts of data. By integrating the attention mechanism into the controller QRNN 204 to determine the relevant past states, training time and training complexity can be decreased by training on only a subset of the data.

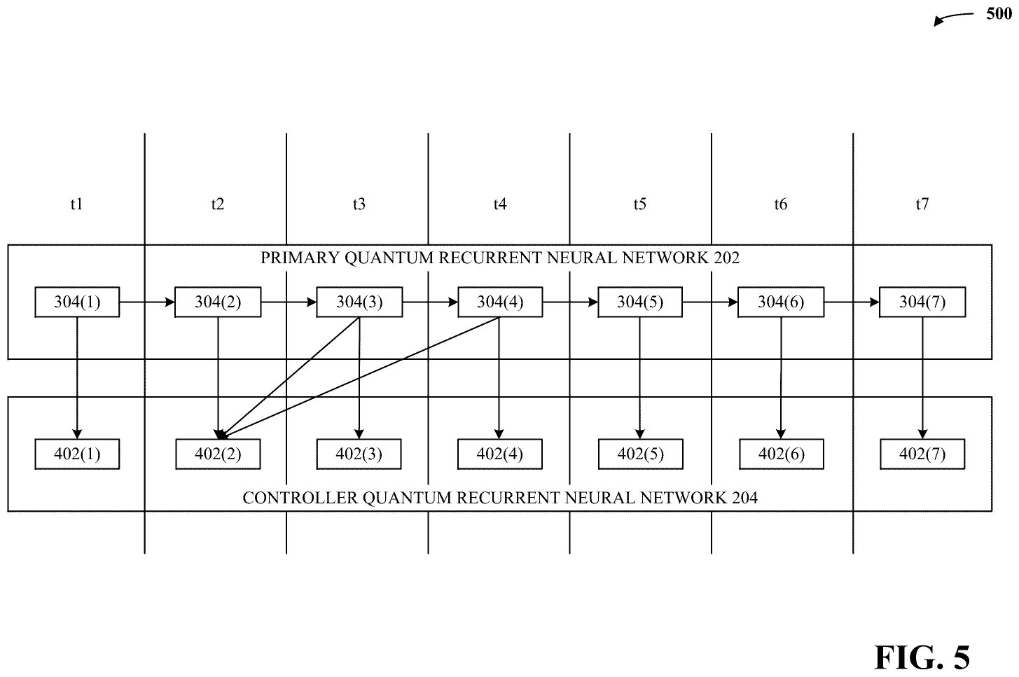

FIG. 5 illustrates an example, non-limiting block diagram 500 of a dual QRNN in accordance with one or more embodiments described herein.

Shown in FIG. 5 is a diagram showing the influence of memory states 402 in generating the set of hidden states 304. As depicted, at a time t1, the hidden state 304(1) can be stored in the augmented memory 206 in the controller QRNN 204 as memory state 402(1).

In various aspects, the controller QRNN 204 can compute the hidden state 304(1) at each time step t. Computation of the hidden state 304(1) are influenced not only by the immediately preceding hidden state hidden state 304(t−1), but also by memory state 402(t−1), memory state 402(1), memory state 402(t+1), and the relevancy score a. In other words, the controller QRNN 204 can generate the hidden states 304 using a function defined by hₜ←QRNN_{c} (hₜ₋₁, Mₜ₋₁, Mₜ, Mₜ₊₁, a), where h denotes the hidden states 304, M denotes the memory states 402, and QRNN_{c} denotes the controller QRNN 204. Determining the hidden state 304(1) based on the memory states 402 can capture contextual information and internal relationships between states. Furthermore, the memory states 402 can be influenced by the attention mechanism by being updated by the controller QRNN 204 using a function defined by Mₜ QRNN_{c} (hₜ₋₁, Mₜ₋₁, Mₜ, Mₜ₊₁, a) to enable more contextually aware generation of the context states 404. Thus, the memory states 402 can be considered as states with continuous attention for determining the context states 404.

FIG. 6 illustrates a block diagram of an example, non-limiting system 600 including a training component and a training dataset that facilitates a dual QRNN with an attention mechanism for time series prediction in accordance with one or more embodiments described herein. As shown, the system 600 can, in some cases, comprise the same components as the system 100, and can further comprise a training component 602 and a training dataset 604.

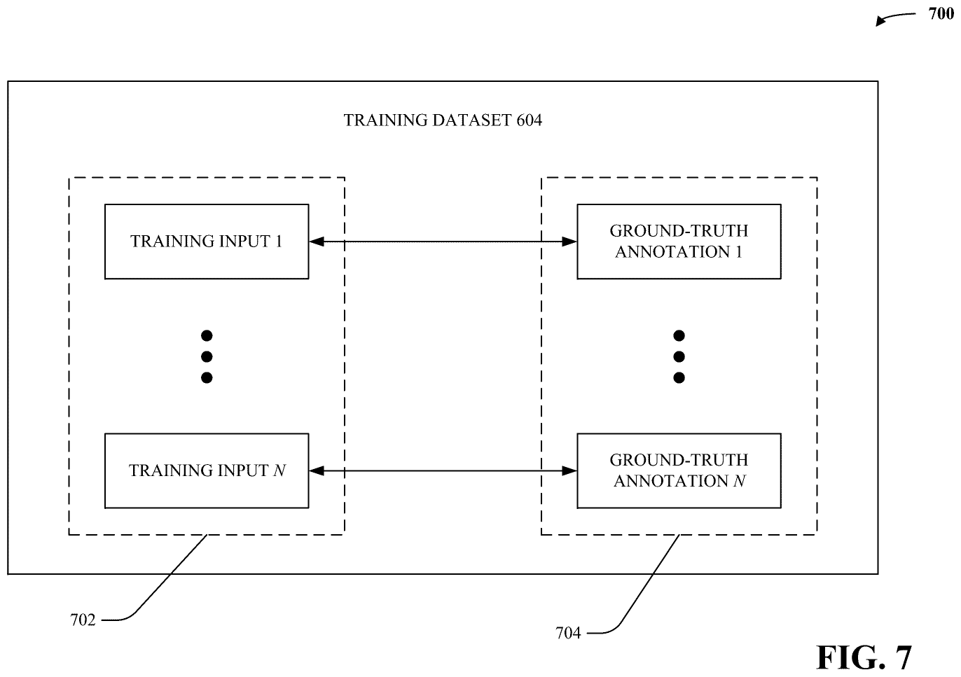

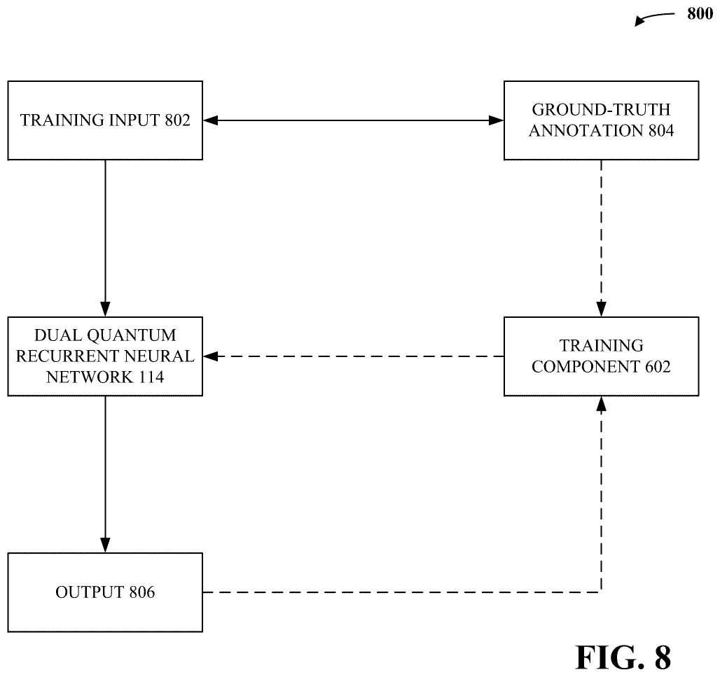

In various aspects, the training component 602 can electronically receive, retrieve, obtain, or otherwise access, from any suitable source, the training dataset 604. In various aspects, the training component 602 can train the dual QRRN 114 based on the training dataset 604. Various non-limiting aspects are described with respect to FIGS. 7-8.

In various instances, the training component 602 can train the dual QRNN 114 using any suitable training paradigm. In some cases, such training can be facilitated in supervised fashion, as described with respect to FIG. 8.

In various cases, if the dual QRNN 114 has not yet undergone any training, the training component 602 can randomly initialize the trainable internal parameters (e.g., convolutional kernels, weight matrices, bias vectors) of the dual QRNN 114. In contrast, if the dual QRNN 114 has already undergone at least some training, the training component 602 can refrain from re-initializing the trainable internal parameters of the dual QRNN 114.

In various aspects, the training component 602 can execute the dual QRNN 114 on a time series of the training dataset 604, thereby causing the dual QRNN 114 to produce some output. In particular, the training component 602 can feed the time series to an input layer of the dual QRNN 114, the time series can complete a forward pass through one or more hidden layers of the dual QRNN 114, the primary QRNN 202, and the controller QRNN 204, and such forward pass can cause an output layer of the dual QRNN 114 to compute the output based on activations provided by the one or more hidden layers.

Note that the format, size, or dimensionality of the output can be controlled or otherwise dictated by the number, arrangement, or sizes of the neurons or of other internal parameters (e.g., convolutional kernels) that are contained in or that otherwise make up the output layer of the dual QRNN 114. So, the output can be forced to have any suitable or any desired format, size, or dimensionality, by adding, removing, or otherwise adjusting neurons or other internal parameters to, from, or within the output layer of the dual QRNN 114. So, the output can be considered as a prediction of the time series (e.g., believes is an accurate prediction of the time series). In various cases, if the dual QRNN 114 has so far undergone no or little training, the output can be highly inaccurate (e.g., can be very different from corresponding ground-truths).

In any case, the training component 602 can compute an error or loss (e.g., mean absolute error (MAE), mean squared error (MSE), cross-entropy error) between the output and the ground-truth. In various aspects, the training component 602 can update the trainable internal parameters of the dual QRNN 114 by performing backpropagation (e.g., stochastic gradient descent) driven by the computed error or loss. More specifically, the training component 602 can update the trainable internal parameters of the VQC of the primary QRNN 202, the VQC of the controller QRNN 204, or the attention mechanism.

In various aspects, such training procedure can be repeated for any suitable number of time-series-and-ground-truth pairs. Such training can ultimately cause the trainable internal parameters of the dual QRNN 114 to become iteratively optimized for accurately predicting time series. Note that the training component 602 can implement any suitable training batch sizes, any suitable training termination criteria, or any suitable error, loss, or objective functions.

In various aspects, during training, the primary QRNN 202 and the controller QRNN 204 can be optimized together. More specifically, parameters of the VQC of the primary QRNN 202, parameters of the VQC of the controller QRNN 204, and parameters of the attention mechanism can be adjusted to minimize the error between the prediction and the ground-truth annotation on the training dataset 604, thereby enhancing the overall predictive accuracy of the dual QRNN 114.

FIG. 7 illustrates an example, non-limiting block diagram 700 of a training dataset for training a dual QRNN with an attention mechanism for time series prediction in accordance with one or more embodiments described herein.

As shown, the training dataset 604 can, in various aspects, comprise a set of training inputs 702 and a set of ground-truth annotations 704.

In various aspects, the set of training inputs 702 can include n inputs for any suitable positive integer n: a training input 702(1) to a training input 702(n). In various instances, a training input can be any suitable electronic data having the same format, size, or dimensionality as the time series 108. In other words, each training input can be time series data, where the time series can comprise continuous data or multi-variate time series data.

In various aspects, the set of ground-truth annotations 704 can respectively correspond (e.g., in one-to-one fashion) to the set of training inputs 702. Thus, since the set of training inputs 702 can have n inputs, the set of ground-truth annotations 704 can have n annotations: a ground-truth annotation 704(1) to a ground-truth annotation 704(n). In various instances, each of the set of ground-truth annotations 704 can have the same format, size, or dimensionality as the prediction 116. That is, each ground-truth annotation can be any suitable electronic data that indicates or represents a prediction that is known or deemed to be manifested in a respective training input. For example, the ground-truth annotation 1 can correspond to the training input 1. Accordingly, the ground-truth annotation 704(1) can be considered as the correct or accurate prediction of a next time step of a first datapoint of a time series. As another example, the ground-truth annotation 704(n) can correspond to the training input 702(n). Accordingly, the ground-truth annotation 704(n) can be considered as the correct or accurate prediction of a next time step of an n-th datapoint of a time series.

FIG. 8 illustrates an example, non-limiting block diagram 800 showing how a dual QRNN with an attention mechanism for time series prediction can be trained in accordance with one or more embodiments described herein.

In various aspects, prior to beginning training, the training component 602 can initialize in any suitable fashion (e.g., via random initialization) trainable internal parameters (e.g., convolutional kernels, weight matrices, bias values) of the dual QRNN 114.

In various embodiments, there can be a training input 802 and a ground-truth annotation 804. When it is desired to train the dual QRNN 114, the training input 802 can be a training time series, and the ground-truth annotation 804 can be correct or accurate prediction that is known or deemed to correspond to the training input 802.

In any case, the training component 602 can execute the dual QRNN 114 on the training input 802, thereby causing the dual QRNN 114 to produce an output 806. More specifically, in some cases, the training component 602 can feed or route the training input 802 to the input layer of the dual QRNN 114, the training input 802 can complete a forward pass through the one or more hidden layers of the dual QRNN 114, the primary QRNN layer, and the controller QRNN layer, and the output layer of the dual QRNN 114 can compute the output 806 based on activation maps or feature maps provided by the one or more hidden layers of the dual QRNN 114.

Note that the format, size, or dimensionality of the output 806 can be dictated by the number, arrangement, sizes, or other characteristics of the neurons, convolutional kernels, or other internal parameters of the output layer (or of any other layers) of the dual QRNN 114. Accordingly, the output 806 can be forced to have any desired format, size, or dimensionality, by adding, removing, or otherwise adjusting characteristics of the output layer (or of any other layers) of the dual QRNN 114.

In various aspects, if the output 806 is produced by the dual QRNN 114, the output 806 can be considered as a prediction that the dual QRNN 114 has generated based on the training input 802. In various instances, the ground-truth annotation 804 can be considered as whatever correct or accurate result (e.g., correct or accurate prediction) that is known or deemed to correspond to the training input 802. Note that, if the dual QRNN 114 has so far undergone no or little training, then the output 806 can be highly inaccurate. In other words, the output 806 can be very different from the ground-truth annotation 804.

In various aspects, the training component 602 can compute an error (e.g., mean absolute error (MAE), mean squared error (MSE), cross-entropy error) between the output 806 and the ground-truth annotation 804. In various instances, the training component 602 can incrementally update the trainable internal parameters of the dual QRNN 114, via backpropagation (e.g., stochastic gradient descent) based on the computed error.

In various cases, such execution-and-update procedure can be repeated for any suitable number input-annotation pairs. This can ultimately cause the trainable internal parameters of the dual QRNN 114 to become iteratively optimized for accurately generating predictions of time series. In various aspects, the training component 602 can utilize any suitable training batch sizes, any suitable error/loss functions, or any suitable training termination criteria.

Although the herein disclosure mainly describes the dual QRNN 114 as being trained in supervised fashion, this is a mere non-limiting example for ease of explanation and illustration. In various embodiments, any other suitable training paradigm can be used to train the dual QRNN 114 such as unsupervised training or reinforcement learning.

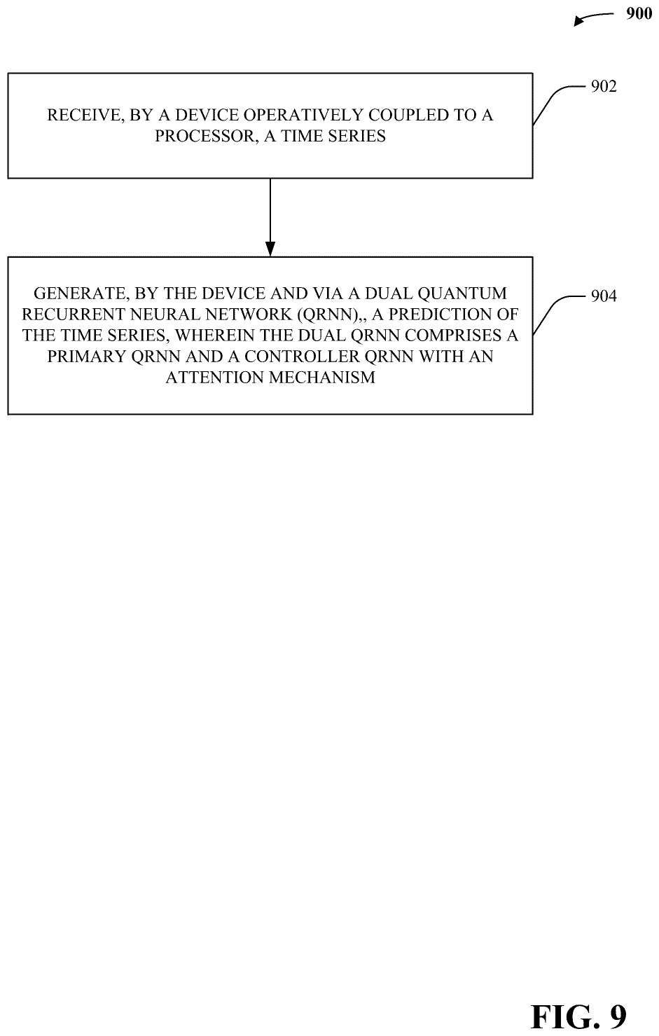

FIG. 9 illustrates a flow diagram of an example, non-limiting computer-implemented method 900 that can facilitate a dual quantum recurrent neural network with an attention mechanism for time series prediction in accordance with one or more embodiments described herein. In various cases, the time series prediction with dual QRNN and attention mechanism system 102 can facilitate the computer-implemented method 900.

In various embodiments, act 902 can include receiving, by a device (e.g., access component 110) operatively coupled to a processor (e.g., 104), a time series (e.g., 108).

In various aspects, act 904 can include generating, by the device (e.g., via prediction component 112) and via a dual QRNN (e.g., 114), a prediction (e.g., 116) of the time series, wherein the dual QRNN comprises a primary QRNN (e.g., 202) and a controller QRNN (e.g., 204) with an attention mechanism.

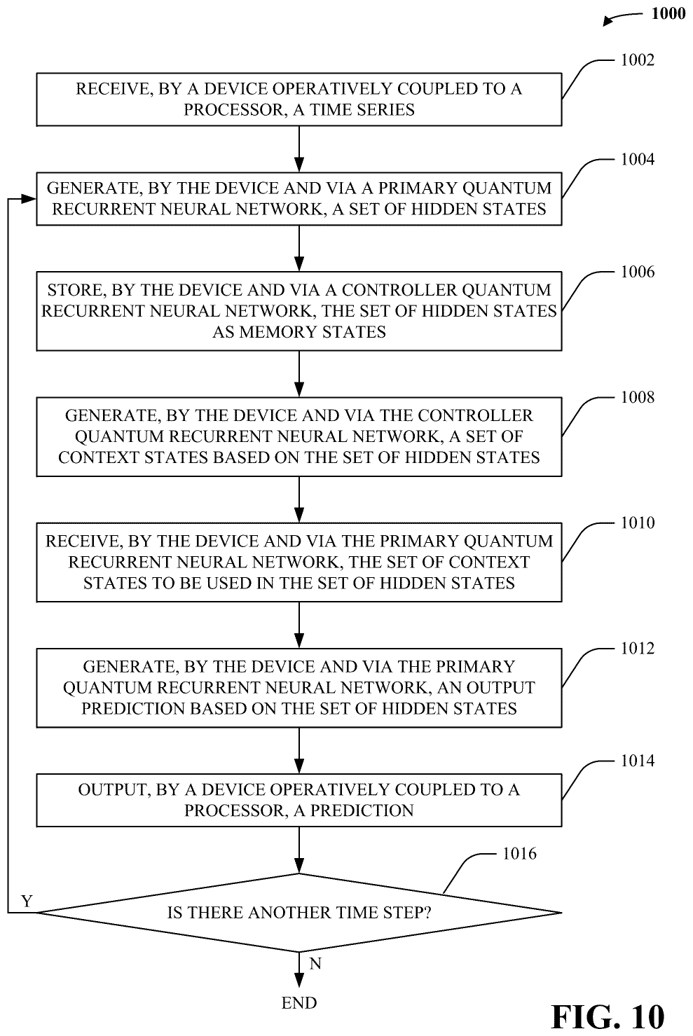

FIG. 10 illustrates a flow diagram of an example, non-limiting computer-implemented method 1000 that can facilitate a dual quantum recurrent neural network with an attention mechanism for time series prediction in accordance with one or more embodiments described herein. In various cases, the time series prediction with dual QRNN and attention mechanism system 102 can facilitate the computer-implemented method 1000.

In various cases, act 1002 can include receiving, by a device (e.g., access component 110) operatively coupled to a processor (e.g., 104), a time series (e.g., 108).

In various aspects, act 1004 can include generating, by the device (e.g., via prediction component 112) and via a primary QRNN (e.g., 202), a set of hidden states (e.g., 304).

In various aspects, act 1006 can include storing, by the device (e.g., via prediction component 112) and via a controller QRNN (e.g., 204), the set of hidden states as memory states. In various aspects, the controller QRNN can comprise an augmented memory (e.g., 206), in which the controller QRNN can store the memory states.

In various cases, act 1008 can include generating, by the device (e.g., prediction component 112) and via the controller QRNN, a set of context states (e.g., 404) based on the set of hidden states. In various embodiments, the controller QRNN can generate the set of context states via an attention mechanism. In various aspects, the controller QRNN can generate the set of context states by determining relevant past states of the primary QRNN based on the memory states.

In various cases, act 1010 can include receiving, by the device (e.g., 202) and via the primary QRNN, the set of context states to be used in the set of hidden states.

In various cases, act 1012 can include generating, by the device (e.g., 202), an output based on the set of hidden states. In various aspects, by using the set of context states as the set of hidden states, the output can be determined based on the relevant past states of the primary QRNN. In various instances, the output can be a prediction of a next time step of the time series.

In various cases, act 1014 can include outputting, by the device (e.g., prediction component 112), a prediction (e.g., 116) of the time series.

In various cases, act 1016 can include determining, by the device (e.g., via prediction component 112), if there is another time step to generate a prediction for. If not, the computer-implemented method 1000 can end. If so, the computer-implemented method 1000 can instead return to act 1004.

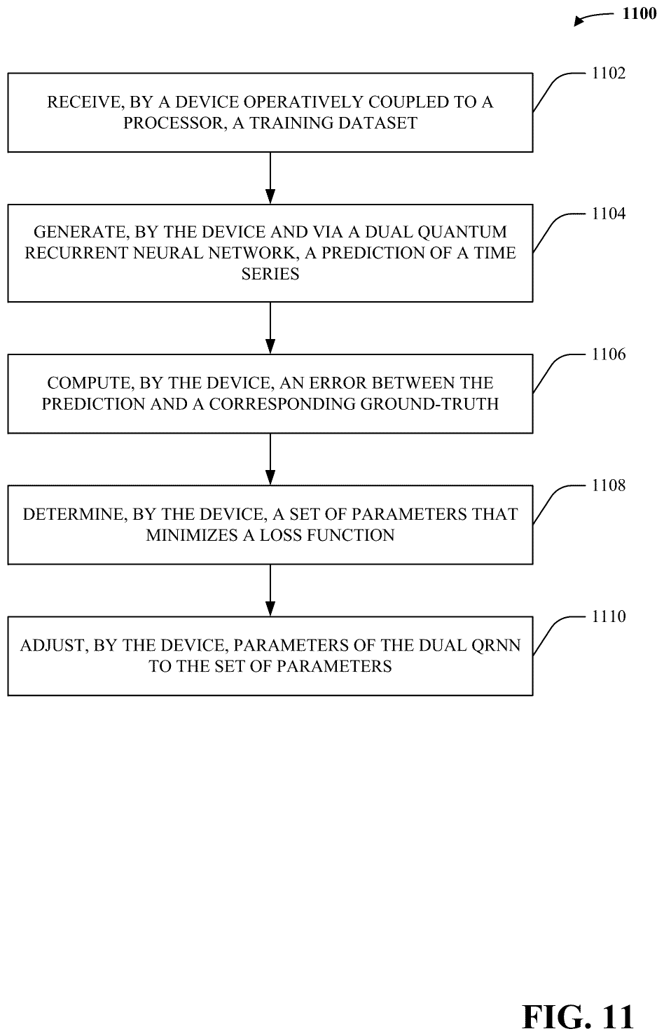

FIG. 11 illustrates a flow diagram of an example, non-limiting computer-implemented method 1100 that can facilitate a dual quantum recurrent neural network with an attention mechanism for time series prediction in accordance with one or more embodiments described herein. In various cases, the time series prediction with dual QRNN and attention mechanism system 102 can facilitate the computer-implemented method 1100.

In various embodiments, act 1102 can include receiving, by a device (e.g., training component 602) operatively coupled to a processor (e.g., 104), a training dataset (e.g., 604).

In various aspects, act 1104 can include generating, by the device (e.g., via prediction component 112) and via a dual QRNN (e.g., 114), a prediction (e.g., 116) of a time series of the training dataset.

In various aspects, act 1106 can include computing, by the device (e.g., via training component 602), an error between the prediction (e.g., 806) and a corresponding ground truth (e.g., 804).

In various aspects, act 1108 can include determining, by the device (e.g., via training component 602), a set of parameters of the dual QRNN that minimizes a loss function.

In various aspects, act 1108 can include adjusting, by the device (e.g., via training component 602), parameters of the dual QRNN to the set of parameters. In various aspects, adjusting the parameters of the dual QRNN can include adjusting parameters of a VQC of the primary QRNN, of the VQC of the controller QRNN, and of the attention mechanism of the controller QRNN.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively train a dual QRNN with an attention mechanism for time series prediction as the one or more embodiments described herein can enable this process. And, neither can the human mind nor a human with pen and paper train a dual QRNN with an attention mechanism for time series prediction, as conducted by one or more embodiments described herein.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

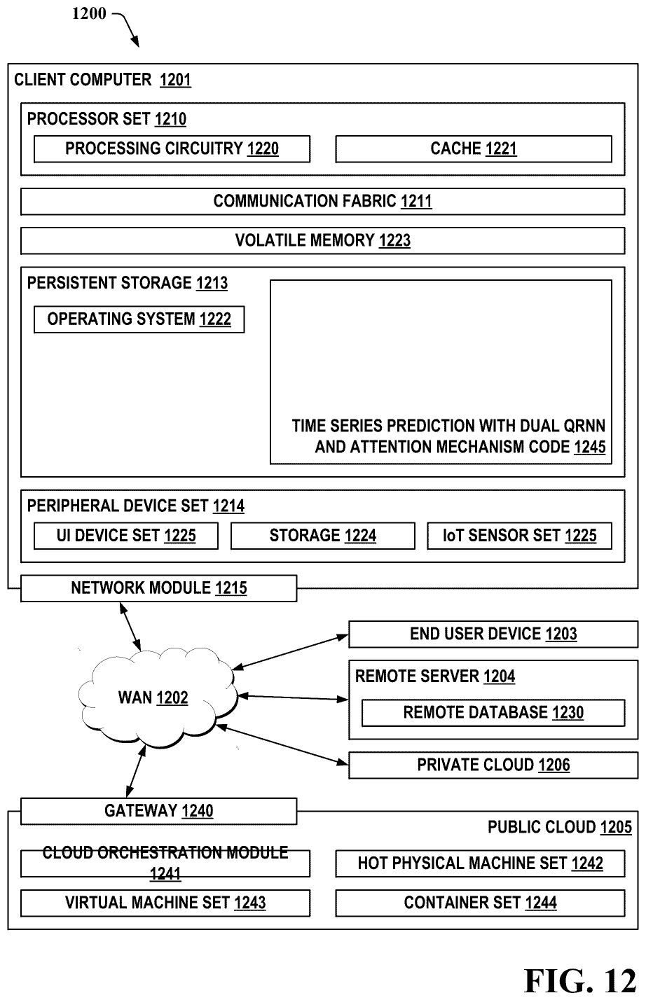

FIG. 12 illustrates a block diagram of an example, non-limiting, operating environment in which one or more embodiments described herein can be facilitated. FIG. 12 and the following discussion are intended to provide a general description of a suitable operating environment 1200 in which one or more embodiments described herein at FIGS. 1-11 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1200 contains an example of an environment for the execution of at least some of the computer code involved in performing the inventive methods, such as time series prediction with dual QRNN and attention mechanism code 1245. In addition to block 1245, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1223, persistent storage 1213 (including operating system 1222 and block 1245, as identified above), peripheral device set 1214 (including user interface (UI), device set 1225, storage 1224, and Internet of Things (IOT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible. Computer 1201 may be located in a cloud, even though it is not shown in a cloud in FIG. 12. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1245 in persistent storage 1213.

COMMUNICATION FABRIC 1211 is the signal conduction paths that allow the various components of computer 1201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1223 is any type of volatile memory now known or to be developed in the future. Examples include dynamic type random access memory (RAM) or static type RAM. Typically, the volatile memory is characterized by random access, but this is not required unless affirmatively indicated. In computer 1201, the volatile memory 1223 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid state storage devices. Operating system 1222 may take several forms, such as various known proprietary operating systems or open source Portable Operating System Interface type operating systems that employ a kernel. The code included in block 1245 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1225 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. IoT sensor set 1225 is made up of sensors that can be used in Internet of Things applications. For example, one sensor may be a thermometer and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be cither volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes at least one of the computer executable components that:
receives a time series; and
generates a prediction of the time series via a dual quantum recurrent neural network (QRNN), the dual QRNN comprising:
a primary QRNN; and
a controller QRNN that determines, via an attention mechanism, relevant past cell states of the primary QRNN, and wherein the primary QRNN generates the prediction of the time series based on the relevant past cell states.

2. The system of claim 1, wherein the primary QRNN comprises hidden states, wherein the primary QRNN generates the prediction based on the hidden states.

3. The system of claim 2, wherein the controller QRNN comprises:
memory states that are hidden states outputted by the primary QRNN, and wherein determining the relevant past cell states via the controller QRNN comprises:
generating, via the attention mechanism, context states that represent an underlying data structure of the time series based on the memory states.

4. The system of claim 3, wherein the dual QRNN comprises:
an augmented memory storage that stores the memory states, wherein the memory states represent attention-infused quantum states of the primary QRNN over time.

5. The system of claim 1, wherein the primary QRNN and the controller QRNN comprise a variational quantum circuit (VQC).

6. The system of claim 3, wherein the primary QRNN uses the context states as the hidden states to generate the prediction or another hidden state.

7. The system of claim 3, wherein generating the context states via the attention mechanism comprises:
weighting the memory states based on the time series and the hidden states by assigning relevancy scores to the memory states.

8. The system of claim 5, wherein the at least one of the computer executable components further:
trains the dual QRNN, wherein training the dual QRNN comprises:
adjusting, based on a loss function, a set of parameters to minimize an error between the prediction and a corresponding ground-truth, wherein the set of parameters comprises parameters of the VQC of the primary QRNN, parameters of the VQC of the controller QRNN, and parameters of the attention mechanism.

9. The system of claim 1, wherein the time series comprises continuous data, a sequential time series, or a time series dataset.

10. The system of claim 1, wherein the controller QRNN determines the relevant past cell states of the primary QRNN for each time step in the time series.

11. A computer-implemented method, comprising:
receiving, by a system operatively coupled to a processor, a time series; and
generating, by the system, a prediction of the time series via a dual quantum recurrent neural network (QRNN), the dual QRNN comprising:
a primary QRNN; and
a controller QRNN that determines, via an attention mechanism, relevant past cell states of the primary QRNN, and wherein the primary QRNN generates the prediction of the time series based on the relevant past cell states.

12. The computer-implemented method of claim 11, wherein the primary QRNN comprises hidden states, wherein the primary QRNN generates the prediction based on the hidden states.

13. The computer-implemented method of claim 12, wherein the controller QRNN comprises:
memory states that are hidden states outputted by the primary QRNN, and wherein determining the relevant past cell states via the controller QRNN comprises:
generating, via the attention mechanism, context states based on the memory states.

14. The computer-implemented method of claim 11, wherein the primary QRNN and the controller QRNN comprise a variational quantum circuit (VQC).

15. The computer-implemented method of claim 14, further comprising:
training, by the system, the dual QRNN, wherein training the dual QRNN comprises:
adjusting, based on a loss function, a set of parameters to minimize an error between the prediction and a corresponding ground-truth, wherein the set of parameters comprises parameters of the VQC of the primary QRNN, parameters of the VQC of the controller QRNN, and parameters of the attention mechanism.

16. The computer-implemented method of claim 11, wherein the time series comprises continuous data, a sequential time series, or a time series dataset.

17. A computer program product for time series prediction, the computer program product comprising a computer readable storage medium having program instructions embodied therewith, the program instructions executable by a processor to cause the processor to:
receive a time series; and
generate a prediction of the time series via a dual quantum recurrent neural network (QRNN), the dual QRNN comprising:
a primary QRNN; and
a controller QRNN that determines, via an attention mechanism, relevant past cell states of the primary QRNN, and wherein the primary QRNN generates the prediction of the time series based on the relevant past cell states.

18. The computer program product of claim 17, wherein the primary QRNN comprises hidden states, wherein the primary QRNN generates the prediction based on the hidden states.

19. The computer program product of claim 18, wherein the controller QRNN comprises:
memory states that are hidden states outputted by the primary QRNN, and wherein determining the relevant past cell states via the controller QRNN comprises:
generating, via the attention mechanism, context states based on the memory states.

20. The computer program product of claim 19, wherein the dual QRNN comprises:
an augmented memory storage that stores the memory states, wherein the memory states represent quantum states of the primary QRNN over time.
